(19) United States
(12) Patent Application Publication
(10) Pub. No.: US 2014/0079008 A1
(43) Pub. Date: Mar. 20, 2014

(54) METHOD AND APPARATUS FOR ALLOCATING RESOURCE OF RESPONSE CONTROL INFORMATION IN WIRELESS COMMUNICATION SYSTEM

(71) Applicant: Donghyun Park, Seoul (KR)

(72) Inventor: Donghyun Park, Seoul (KR)

(73) Assignee: Pantech Co., Ltd., Seoul (KR)

(21) Appl. No.: 14/114,929

(22) PCT Filed: Apr. 16, 2012
(86) PCT No.: PCT/KR2012/002875

§ 371 Date: Oct. 31, 2013

(30) Foreign Application Priority Data
May 2, 2011 (KR) 10-2011-0041686

(51) Int. Cl. H04W 72/04

(52) U.S. Cl. CPC H04W 72/0413
USPC 370/329

(57) ABSTRACT

A method and apparatus for allocating a resource of response control information in a wireless communication system are disclosed. A method for allocating the resource of the response control in formation comprises: including in one downlink control channel information for indicating the response control information with regard to data which is transmitted from at least two component carriers; transmitting at least two data channels including the control channel and the data to a user equipment; and receiving from the user equipment the response control information, which is included in the resource of the response control information that is indicated, and deciding whether to retransmit same. The information for indicating the resource of the response control information with respect to data, which is transmitted from a secondary component carrier (SCC), from the data is indicated by being included in the control channel or through signaling by an upper layer.

### CROSS-REFERENCE TO RELATED APPLICATIONS

This application is the National Stage Entry of International Application PCT/KR2012/002875, filed on Apr. 16, 2012, and claims priority from and the benefit of Korean Patent Application No. 10-2011-0041686, filed on May 2, 2011, all of which are incorporated herein by reference for all purposes as if fully set forth herein.

### BACKGROUND

1. Field

The present invention relates to a method and apparatus for allocating a resource required for transmitting response control information transmitted on a component carrier in a wireless communication system that uses one or multiple component carriers (CC).

2. Discussion of the Background

As communication systems have developed, various wireless terminals have been utilized by consumers such as companies and individuals.

Current mobile communication systems, for example, 3GPP, LTE (Long Term Evolution), LTE-A (LTE-Advanced), and the like, may be high capacity communication systems capable of transmitting and receiving various types of data such as image data, wireless data, and the like, beyond providing a sound-based service. Accordingly, there is a desire for a technology that transmits high capacity data, which is comparable to a wired communication network. Also, the system is required to include an appropriate error detection scheme that minimizes a loss of information and increases transmission efficiency of the system so as to enhance performance of the system.

Also, there are provided various technologies for determining whether transceived information is accurately received. As a communication system has developed, a technology that flexibly and extensively determines transceived information has been required. Particularly, in a case in which a plurality of antennas are used or various carriers are utilized, as an amount of transceived data increases, an amount of response control information expended for determining data and for transmitting a result of the determination increases. Therefore, there is a desire for a method that effectively allocates a resource through which response control information is transferred.

### SUMMARY

The present invention relates to a wireless communication system, and an aspect of the present invention is to provide a method and apparatus for allocating a resource of response control information.

When one or more component carriers are used, the present invention includes indication information in a control channel so that a user equipment determines a resource to which response control information is to be included based on an increase in an amount of transceived data and a configuration of a network.

In accordance with an aspect of the present invention, there is provided a method of allocating a resource of response control information, the method including: including, in a single downlink control channel, information indicating a resource of response control information with respect to data transmitted through two or more component carriers; transmitting, to a user equipment, the control channel and two or more data channels including the data; and receiving, from the user equipment, the response control information included in the indicated response control information resource, and determines whether to perform retransmission, wherein information that indicates a resource of response control information with respect to data transmitted on an SCC (Secondary Component Carrier) from among the data is included in the control channel, or is indicated by signaling of a higher layer.

In accordance with another aspect of the present invention, there is provided a method of allocating a resource of response control information, the method including: receiving, from a base station, a single downlink control channel and a data channel that is indicated by the downlink channel and is transmitted through two or more component carriers; and calculating, from the received control channel, information indicating a resource to which response control information with respect to data included in the data channel is to be included, and including the response control information with respect to the data in the resource for transmission to the base station, wherein information indicating a resource of response control information with respect to data transmitted on an SCC (Secondary Component Carrier) from among the data is included in the single control channel, or is indicated by signaling of a higher layer.

In accordance with another aspect of the present invention, there is provided a method of allocating a resource of response control information, the method including: including information indicating a resource of response control information with respect to one or more pieces of data transmitted on a PCC (Primary Component Carrier) and information indicating a resource of response control information with respect to two or more pieces of data transmitted on an SCC (Secondary Component Carrier) in a downlink control channel of the PCC or in downlink control channels of the PCC and an SCC; transmitting, to a user equipment, a control channel and three or more data channels including the data; and receiving, from the user equipment, response control information included in the indicated response control information resource, and determining whether to perform retransmission, wherein the information indicating the resource of the response control information with respect to the data transmitted on the SCC is included in the control channel or is indicated by signaling of a higher layer.

In accordance with another aspect of the present invention, there is provided a method of allocating a resource of response control information, the method including: receiving, from a base station, a control channel and three or more data channels including data, wherein information indicating a resource of response control information with respect to one or more pieces of data transmitted on a PCC (Primary Component Carrier) and information indicating a resource of response control information with respect to two or more pieces of data transmitted on an SCC(Secondary Component Carrier) are included in a downlink control channel of the PCC or in downlink control channels of the PCC and an SCC; and calculating, from the received control channel, information that indicates a resource to which response control information with respect to the data included in the data channel is to be included, and including the response control information with respect to the data in the resource for transmission to the base station, wherein the information indicating the resource of the response control information with respect to the data transmitted on the SCC is included in the control channel or is indicated by signaling of a higher layer.

In accordance with another aspect of the present invention, there is provided a base station in a wireless system that uses one or more component carriers, the base station including: a response control information resource allocating unit to calculate information indicating a resource of response control information with respect to data transmitted through two or more component carriers; a controller to include the information in a single downlink control channel; and a transceiving unit to transmit the control channel and two or more data channels including the data to a user equipment, and to receive, from the user equipment, the response control information included in the indicated response control information resource, wherein the controller determines whether to perform retransmission using the received response control information; and information indicating a resource of response control information with respect to data transmitted on an SCC (Secondary Component Carrier) from among the data is included in the control channel or is indicated by signaling of a higher layer.

In accordance with another aspect of the present invention, there is provided a user equipment, including: a transceiving unit to receive, from a base station, a single downlink control channel and a data channel that is indicated by the downlink channel and is transmitted through two or more component carriers; a response control information resource indicator extracting unit to calculate, from the received control channel, information indicating a resource to which response control information with respect to data included in the data channel is to be included; and a controller to include the response control information with respect to the data in the resource, wherein the transceiving unit transmits, to the base station, the resource including the response control information as a wireless signal, and information indicating a resource of response control information with respect to data transmitted on an SCC(Secondary component Carrier) from among the data is included in the control channel or is indicated by signaling of a higher layer.

### BRIEF DESCRIPTION OF THE DRAWINGS

FIG. 1 illustrates a wireless communication system according to embodiments of the present invention;

FIG. 2 illustrates a method of allocating a PUCCH resource in an FDD environment according to an embodiment of the present invention;

FIG. 3 is a diagram illustrating an enhanced CA (PDSCH/PUSCH scheduling on multiple CCs by one PDCCH in CA) in which scheduling of a PDSCH/PUSCH existing on multiple CCs is performed by a single PDCCH according to an embodiment of the present invention;

FIG. 4 is a diagram illustrating an example of allocating a resource of response control information through an additional ARI field according to an embodiment of the present invention;

FIG. 5 is a diagram illustrating an example of allocating all resources of response control information using a CCE of a single PDCCH according to an embodiment of the present invention;

FIG. 6 is a diagram illustrating an example in which A/N information of a PDSCH transmitted on an SCC allocates a resource in a semi-static manner through RRC signaling and the like;

FIG. 7 is a diagram illustrating allocation of a resource using a CIF field according to an embodiment of the present invention;

FIG. 8 is a diagram illustrating a case of allocating a resource for transmission of PUCCH format 3 using a single PDCCH;

FIG. 9 is a diagram illustrating a process in which a base station transmits a PDCCH so as to enable allocation of a resource of a PUCCH according to an embodiment of the present invention;

FIG. 10 is a diagram illustrating a process in which a user equipment transmits response control information by deriving a resource of the response control information using a PDCCH transmitted for enabling allocation of a resource of a PUCCH according to an embodiment of the present invention;

FIG. 11 is a diagram illustrating a configuration of an apparatus that transmits a PDCCH for enabling allocation of a resource of a PUCCH according to an embodiment of the present invention; and

FIG. 12 is a diagram illustrating a configuration of an apparatus that is assigned with a resource of a PUCCH and transmits response control information according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

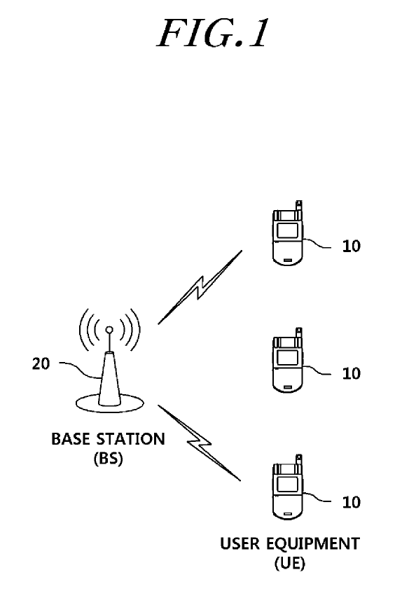

FIG. 1 illustrates a wireless communication system according to embodiments of the present invention.

The wireless communication system may be widely installed so as to provide various communication services, such as a voice service, packet data, and the like.

Referring to FIG. 1, the wireless communication system includes a User Equipment (UE) 10 and a Base Station (BS or eNB) 20. Throughout the specifications, the user equipment 10 may be an inclusive concept indicating a user terminal utilized in wireless communication, including a UE (User Equipment) in WCDMA, LTE, HSPA, and the like, and an MS (Mobile Station), a UT (User Terminal), an SS (Subscriber Station), a wireless device, and the like in GSM.

The base station 20 or a cell may refer to a station where communication with the user equipment 10 is performed, and may also be referred to as a Node-B, an eNB (evolved Node-B), a sector, a site, a BTS (Base Transceiver System), an access point, a relay node, and the like.

That is, the base station 20 or the cell may be construed as an inclusive concept including a partial area covered by a BSC (Base Station Controller) in CDMA, a NodeB of WCDMA, an eNB or a sector (site) in LTE, and the like, and may be a concept including various coverage areas such as a mega cell, a macro cell, a micro cell, a pico cell, a femto cell, a communication range of a relay node, and the like.

In the specifications, the user equipment 10 and the base station 20 are used as two inclusive transceiving subjects, which are to embody the technology and technical concepts described in the specifications, and may not be limited to a predetermined term or word. The user equipment 10 and the base station 20 are used as two inclusive Uplink (UL) and Downlink (DL) transceiving subjects, which are used to embody the technology and technical concepts described in the specifications, and may not be limited to a predetermined term or word.

The wireless communication system may utilize varied multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, OFDM-CDMA, and the like.

Uplink transmission and downlink transmission may be performed based on a TDD (Time Division Duplex) scheme that performs transmission based on different times, or based on an FDD (Frequency Division Duplex) scheme that performs transmission based on different frequencies.

An embodiment of the present invention may be applicable to resource allocation in asynchronous wireless communication that is advanced through GSM, WCDMA, and HSPA, to be LTE and LTE-advanced, and may be applicable to resource allocation in synchronous wireless communication that is advanced through CDMA and CDMA-2000, to be UMB. Embodiments of the present invention may not be limited to a specific wireless communication field, and may be applicable to all technical fields to which a technical idea of the present invention is applicable.

In LTE, a standard may be developed by forming an uplink (UL) and a downlink (DL) based on a single carrier or a pair of carriers. The uplink and the downlink may transmit control information through a control channel, such as a PDCCH (Physical Downlink Control CHannel), PCFICH (Physical Control Format Indicator CHannel), PHICH (Physical Hybrid ARQ Indicator CHannel), PUCCH (Physical Uplink Control CHannel), and the like, and may be configured as a data channel, such as PDSCH (Physical Downlink Shared CHannel), PUSCH (Physical Uplink Shared CHannel), and the like, so as to transmit data.

LTE uses a standard based on a single carrier as a base and has discussed coupling of a few bands having a bandwidth of 20 MHz or less, whereas LTE-A has discussed a band of a component carrier having a bandwidth of 20 MHz or more. LTE-A has discussed a multiple-carrier aggregation (hereinafter referred to as a ‘CA’) by taking backward compatibility into consideration based on the base standard of LTE. In an uplink and a downlink, a maximum of 5 carriers are taken into consideration. The number of carriers may be increased or decreased from 5 carriers based on a system environment, and the present invention may not be limited thereto.

There are Uplink ACK/NACK (ACKnowledgement/Negative ACKnowledgement) transmission and uplink channel information transmission including a CQI (Channel Quality Indicator, hereinafter referred to as a “CQI”), a PMI (Precoding Matrix Indicators referred to as a “PMI”), and an RI (Rank Indicator, referred to as a “RI”) among the various items that are taken into consideration for designing a control channel in a CA.

In LTE-A, backward compatibility of 3GPP LTE Rel-8 is basically taken into consideration to form a CA. Transceiving of CQI/PMI/RI information defined as a standard in LTE Rel-8 is performed by various schemes through an uplink control channel such as a PUCCH (Physical Uplink Control Channel) and a PUSCH (Physical Uplink Shared Channel).

In a case of the CA in LTE-A, a plurality of component carriers exist and an amount of information transmitted through a control channel of an uplink increases based on a number of the carriers and thus, resource allocation performed by forming a resource block group for each carrier may be inefficient. Particularly, in a case of the CA in LTE-A, there may be an asymmetric situation in which a number of uplink carriers is different from a number of downlink carriers. When an amount of information transmitted through a control channel of the uplink increases based on a number of carriers, resource allocation performed by forming a resource block group for each carrier may be more inefficient. Therefore, a scheme of allocating a resource of response control information (Ack/Nack Control information) such as ACK/NACK transmitted through a control channel in an uplink, even in the asymmetric situation, will be described. The response control information includes ACK/NACK control information, for example, response information such as ACK/NACK. The ACK/NACK control information may include the ACK/NACK information as it is, or may convert the information to be more robust.

The wireless communication system according to an embodiment of the present invention may support an uplink and/or downlink HARQ, and may use a CQI (channel quality indicator) for link adaptation. Also, a multiple access scheme for downlink transmission and a multiple access scheme for uplink transmission may be different from each other. For example, a downlink may use OFDMA (Orthogonal Frequency Division Multiple Access) and an uplink may use SC-FDMA (Single Carrier-Frequency Division Multiple Access).

Layers of a radio interface protocol between a user equipment and a network may be distinguished as a first layer (L1), a second layer (L2), and a third layer (L3), based on three lower layers of a well-known Open System Interconnection (OSI) model in a communication system, and a physical layer of the first layer may provide an information transfer service using a physical channel.

An embodiment of the present invention may be applied to a CA. The CA refers to an environment where a base station and a user equipment transmit and receive a signal using a plurality of component carriers. The plurality of component carriers may be adjacent to one another, or may not be adjacent to one another since a frequency band is spaced apart from one another. Also, a downlink component carrier and an uplink component carrier exist independently and thus, a number of downlink component carriers and a number of uplink component carriers may be the same as or different from one another. The plurality of component carriers may include at least one primary component carrier (PCC) and at least one secondary component carrier (SCC) which is different from the PCC. A main measurement signal or control information may be transceived through a PCC, and an SCC may be allocated through a PCC. The PCC is also referred to as a PCell (Primary Cell), and the SCC is also referred to as an SCell (Secondary Cell).

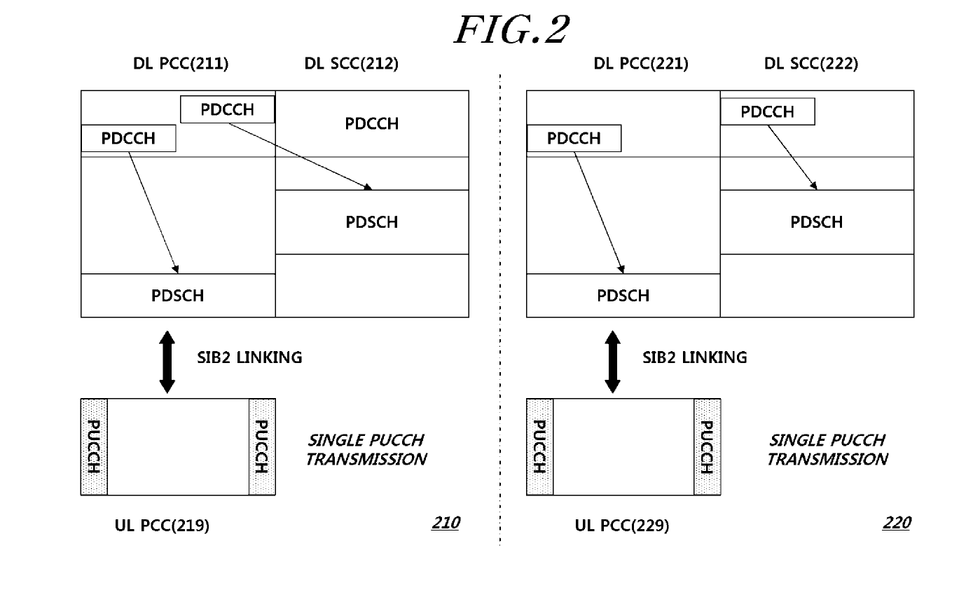

FIG. 2 illustrates a method of allocating a resource of a PUCCH in an FDD environment according to an embodiment of the present invention.

FIG. 2 illustrates a resource allocation scheme for PUCCH format 1b through channel selection in a CA environment of an FDD where one or more serving cells exist.

The diagram 210 of FIG. 2 is an example of cross carrier scheduling performed in a PCC, and the diagram 220 shows that a PDCCH existing in each CC indicates a PDSCH in a corresponding CC by applying a general scheduling.

In the diagram 210, PDCCHs transferred through a DL PCC 211 are associated with a PDSCH in the DL PCC 211 and a PDSCH in a DL SCC 212. Conversely, in the diagram 220, each of a PDCCH transferred through a DL PCC 221 and a PDCCH transferred through a DL SCC 222 indicates a PDSCH in a corresponding CC.

In this example, PUCCH transmission is performed on only a single UL PCC 219 or 229. The UL PCC 219 or 299 is in a SIB2 linking relationship with a DL PCC. Resource allocation schemes for the PUCCH transmission include: i) a scheme of using information of a PDCCH transferred through a DL PCC or information of an added field, ii) a scheme of using a TPC (Transmit Power Control) field and information of a PDCCH transferred through a DL SCC in a case of SPS(Semi-Persistent Scheduling), and iii) a scheme of deriving a resource through RRC signaling, and the like. Detailed descriptions thereof will be provided as follows. Hereinafter, a field refers to an area where information is stored, and has a meaning identical to an area.

Table 1 shows a mapping relationship between a HARQ-ACK and a CC for HARQ-ACK channel selection, in which a transmission block and a serving cell are mapped to HARQ-ACK(j).

TABLE 1

| | HARQ-ACK(j) | | | |
|---|---|---|---|---|
| A | HARQ-ACK(0) | HARQ-ACK(1) | HARQ-ACK(2) | HARQ-ACK(3) |
| 2 | TB1 Primary cell | TB2 Secondary cell | NA | NA |
| 3 | TB1 Serving cell1 | TB2 Serving cell1 | TB3 Serving cell2 | NA |
| 4 | TB1 Primary cell | TB2 Primary cell | TB3 Secondary cell | TB4 Secondary cell |

First, for allocation of a resource using a PDCCH transferred through a PCC, it is assumed that a maximum of 2 CWs (Code Word) are transmitted by each DL CC based on a PDCCH transferred through a PCC in a CA environment (A: PUCCH resources, n_{PUCCH, i}⁽¹⁾, 0≦i≦A−1, each PUCCH resource (n_{PUCCH, i}⁽¹⁾, n_{PUCCH, i+1}⁽¹⁾) may be calculated from a PDCCH of a DL PCC as shown in following Equation 1. Two CWs are transmitted and a resource for carrying a piece of A/N (Ack/Nack) information for each CW may be required. When 2 CWs are transmitted, resources for carrying 2 pieces of A/N information may be required. n_{CCE,i} denotes an index of a first CCE (Control Channel Element) from among CCEs forming a single PDCCH, and N_{PUCCH}⁽¹⁾ denotes information set in advance in a higher layer.

n_{PUCCH,i}⁽¹⁾=n_{CCE,i}+N_{PUCCH}⁽¹⁾,

n_{PUCCH,i+1}⁽¹⁾=n_{CCE,i}+1+N_{PUCCH}⁽¹⁾ [Equation 1]

In a case of SPS transmission, a resource n_{PUCCH, i}⁽¹⁾ is derived with reference to Table 2. Information associated with a PUCCH resource set in a higher layer may be determined, based on a value of a ‘TPC Command for PUCCH’ field during the SPS transmission of Table 2. In a case of a transmission mode (TM mode) that supports 2 CWs, a PUCCH resource for supporting MIMO transmission is derived based on based on n_{PUCCH, i}⁽¹⁾ obtained through Table 2 as shown in n_{PUCCH, i+1}⁽¹⁾=n_{PUCCH, i}⁽¹⁾+1. In this manner, a resource for a 2^{nd} CW may be derived.

TABLE 2
PUCCH resource information in downlink SPS

| Value of ‘TPC | |
|---|---|
| command for PUCCH’ | n_{PUCCH}^{(1,p)} |
| ‘00’ | The first PUCCH resource value configured by |
| | the higher layers |
| ‘01’ | The second PUCCH resource value configured |
| | by the higher layers |
| ‘10’ | The third PUCCH resource value configured by |
| | the higher layers |
| ‘11’ | The fourth PUCCH resource value configured |
| | by the higher layers |

SPS refers to a scheme of scheduling a resource in a semi-static manner during a predetermined period of time. When the SPS is activated, a base station may not need to transmit scheduling information for each subframe. In general, the SPS may be applied to transmission and reception of voice data such as VoIP (Voice over IP) of which a resource has little change after it is allocated once, but this may not be limited thereto. Instruction of activation or deactivation of the SPS is performed through a PCC. Dynamic scheduling refers to PDSCH transmission indicated by a PDCCH transmitted for each subframe, unlike the SPS.

A resource in which A/N response control information with respect to a PDSCH transmitted on an SCC is to be included may be derived with reference to Table 3. In a case of a TM mode that supports 2 CWs, (n_{PUCCH, i}⁽¹⁾, n_{PUCCH, i+1}⁽¹⁾) resources may be derived through Table 3. A lower field performs indication by reusing a TPC field (2 bits) in a PDCCH that indicates allocation of a PDSCH transmitted on an SCC.

TABLE 3
PUCCH resource information associated with a HARQ-ACK resource
that is applicable to a PUCCH (or is associated with a PUCCH)

| Value of | |
|---|---|
| ‘HARQ-ACK Resource | |
| for PUCCH’ | n_{PUCCH,i}⁽¹⁾ |
| ‘00’ | The 1st PUCCH resource value configured |
| | by the higher layers |
| ‘01’ | The 2^{nd} PUCCH resource value configured |
| | by the higher layers |
| ‘10’ | The 3^{rd} PUCCH resource value configured |
| | by the higher layers |
| ‘11’ | The 4^{th} PUCCH resource value configured |
| | by the higher layers |

Scheduling of a PDSCH/PUSCH existing on multiple cells may be performed through a single PDCCH. Under an enhanced CA environment, this refers to allocation of multiple PDSCHs through a single PDCCH. In this case, new resource allocation which is different from existing PUCCH resource allocation may be required as follows. A scheme that embodies a single PUCCH format 1b using channel selection through a scheme of allocating multiple PUCCH resources using a single PDCCH (Single PUCCH format 1b with channel selection using several PUCCH resources derived from one PDCCH), and a scheme that allocates a resource for PUCCH format 3 transmission from a single PDCCH (PUCCH format 3 transmission using format 3 resource derived from one PDCCH) will be described.

First, a resource allocation scheme for the PUCCH format 1b through channel selection will be described.

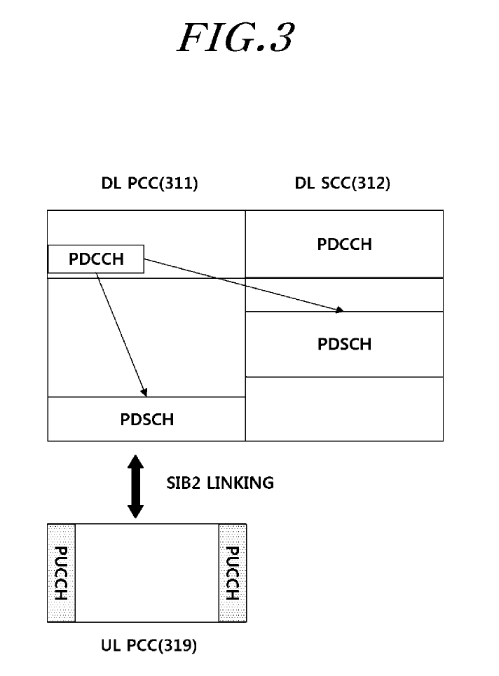

FIG. 3 is a diagram illustrating an enhanced CA in which scheduling of a PDSCH/PUSCH existing on multiple CCs is performed by a single PDCCH (PDSCH/PUSCH scheduling on multiple CCs by one PDCCH in CA) according to an embodiment of the present invention.

FIG. 3 is one of the scheduling methods that may be discussed in the enhanced CA environment. That is, scheduling of a PDSCH/PUSCH transmitted on multiple cells (a PCC 311 and an SCC 312) may be performed through a single PDCCH of a DL PCC 311 (by using new DCI format for PDSCH/PUSCH on multiple cells). The PDCCH of the diagram 311 of FIG. 3 may be an enhanced PDCCH. In this example, newly allocating a portion of PUCCH format 1/1a/1b resources with respect to a PDSCH indicated by the enhanced PDCCH is required. A scenario of FIG. 3 is an environment in which A/N bits with respect to multiple DL CCs are transmitted on only an existing UE-specific UL CC, and assumes a case in which a single PUCCH is transmitted.

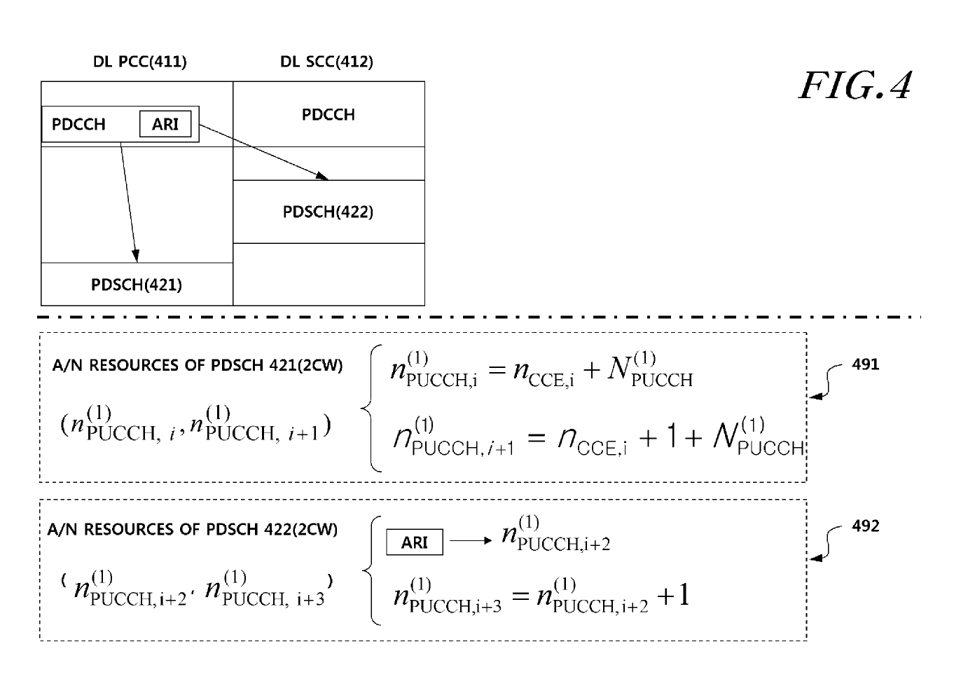

In a case of FIG. 3, a separate ARI field (ACK/NACK Resource Indicator, ARI, Response Control Information Resource Indicator) may be provided for two or more PDSCHs allocated through a single PDCCH. In a case of FIG. 2, when each PDCCH in a DL PCC 211 indicates a different PDSCH, a TPC field of at least one of the PDCCHs may be reused as an ARI. For example, a TPC field in a PDCCH transmitted on a PCell is used for controlling power, and a TPC field in a PDCCH transmitted on an SCell is reused as an ARI field. However, in an embodiment of FIG. 3, a single PDCCH exists and thus, only a single TPC field exists. Accordingly, reusing the TPC field as an ARI value is impossible. Therefore, FIG. 4 illustrates an example of using an additional ARI field.

FIG. 4 is a diagram illustrating an example of allocating a resource of response control information through an additional ARI field according to an embodiment of the present invention.

As described in FIG. 3, indicating two PDSCHs using a single PDCCH and allocating a resource of response control information with respect to each PDSCH are required. In a case of a transmission mode of FIG. 3, a TPC field is not reused and an additional ARI field (Explicit ARI field) is included in all related DCI formats for provision. For this, additional RRC signaling or dynamic signaling that may activate a transmission scheme (PDSCH/PUSCH on Multiple cells by one PDCCH) of FIG. 3 is required. Through the signaling, when the transmission scheme of FIG. 3 is activated, a user equipment determines that multiple PDSCHs/PUSCHs indicated by a single PDCCH are transmitted, and determines each resource of response control information.

As illustrated in FIG. 4, A/N with respect to a PDSCH 421 transmitted on a PCC is assigned with a resource using a corresponding PDCCH, and A/N with respect to a PDSCH 422 transmitted on an SCC is assigned with a resource using a newly added ARI field. When it is assumed that a maximum of 2 CWs are transmitted by each DL CC based on a PDCCH transferred through a PCC in a CA environment (A PUCCH resources, n_{PUCCH, i}⁽¹⁾, 0≦i≦A−1), a resource of (n_{PUCCH,i}⁽¹⁾,n_{PUCCH,i+1}⁽¹⁾) is required as resources (2 CWs transmission) with respect to A/N of the PDSCH 421 transmitted on a PCC, and for this, n_{CCE,i} and N_{PUCCH}⁽¹⁾ calculated from a PDCCH are used. Two resources are calculated by applying Equation 1 as described above, as illustrated in the diagram 491.

In a case of SPS transmission on a PCC, a resource (n_{PUCCH, i}⁽¹⁾) of the PDSCH 421 transmitted on a PCC is derived with reference to Table 2. In a case of 2 CWs, a resource of (n_{PUCCH, i}⁽¹⁾, n_{PUCCH, i+1}⁽¹⁾) is required, and a resource (n_{PUCCH, i+1}⁽¹⁾) with respect to a 2^{nd} CW is derived by a scheme (n_{PUCCH, i+1}⁽¹⁾=n_{PUCCH, i}⁽¹⁾+1) of adding 1 to n_{PUCCH, i}⁽¹⁾. The resources of the remaining SCC may be derived through a PDCCH associated with the SCC, as shown in Equation 1.

For A/N resources (n_{PUCCH,i+2}⁽¹⁾, n_{PUCCH,i+3}⁽¹⁾) with respect to the PDSCH 422 transmitted on the SCC, a value of a newly added ARI field (2 bits) is used. A resource (n_{PUCCH,i+2}⁽¹⁾) may be derived by applying a value of an ARI field to Table 4 which is based on Table 3. In a case of a TM mode that supports 2 CWs, a resource may be derived based on a scheme of adding 1 to a resource (n_{PUCCH,i+2}⁽¹⁾) with respect to a first CW, based on n_{PUCCH,i+3}⁽¹⁾=n_{PUCCH,i+2}⁽¹⁾+1, as illustrated in the diagram 492.

TABLE 4
mapping of single response control information resource and ARI

| ARI | n_{PUCCH,i+2}⁽¹⁾ |
|---|---|
| ‘00’ | The 1st PUCCH resource value configured by the higher layers |
| ‘01’ | The 2^{nd} PUCCH resource value configured by the higher layers |
| ‘10’ | The 3^{rd} PUCCH resource value configured by the higher layers |
| ‘11’ | The 4^{th} PUCCH resource value configured by the higher layers |

Mapping may be performed to enable an ARI field to indicate a pair of two or more resources. A/N resources with respect to the PDSCH 422 transmitted on an SCC may be derived based on information that indicates a pair of resources (n_{PUCCH,i+2}⁽¹⁾, n_{PUCCH,i+3}⁽¹⁾) of Table 5.

TABLE 5
Mapping of two response control information resources and ARI

| | Two resources of response control |
|---|---|
| ARI | information (n_{PUCCH,i+2}⁽¹⁾, n_{PUCCH,i+3)}⁽¹⁾ |
| ‘00’ | {The 1st PUCCH resource value configured by the higher layers, |
| | The 2^{nd} PUCCH resource value configured by the higher layers} |
| ‘01’ | {The 3^{rd} PUCCH resource value configured by the higher layers, |
| | The 4^{th} PUCCH resource value configured by the higher layers} |
| ‘10’ | {The 5^{th} PUCCH resource value configured by the higher layers, |
| | The 6^{th} PUCCH resource value configured by the higher layers} |
| ‘11’ | {The 7^{th} PUCCH resource value configured by the higher layers, |
| | The 8^{th} PUCCH resource value configured by the higher layers} |

Tables 4 and 5 show mapping information that may allocate one or two resources of response control information through a single ARI value.

This will be described as follows.

With respect to the PDSCH 221 transmitted through a PCC, a resource may be allocated through a PDCCH. In this case, a resource may be allocated with respect to a maximum of 2 CWs. With respect to the PDSCH 222 transmitted on an SCC, a resource may to be allocated using a value of a newly added ARI field. In this case, a resource may be derived by combining a value of the ARI field and Table 4. In a case of 2 CWs, a resource with respect to a second CW may be derived by adding 1 based on Table 4, or resources associated with both of the 2 CWs may be derived by applying Table 5.

In a case of SPS transmission, a resource of response control information of the PDSCH 221 transmitted on a PCC is derived referring to Table 2, and a resource with respect to the PDSCH 222 transmitted on an SCC may be derived through a PDCCH transmitted on an SCC.

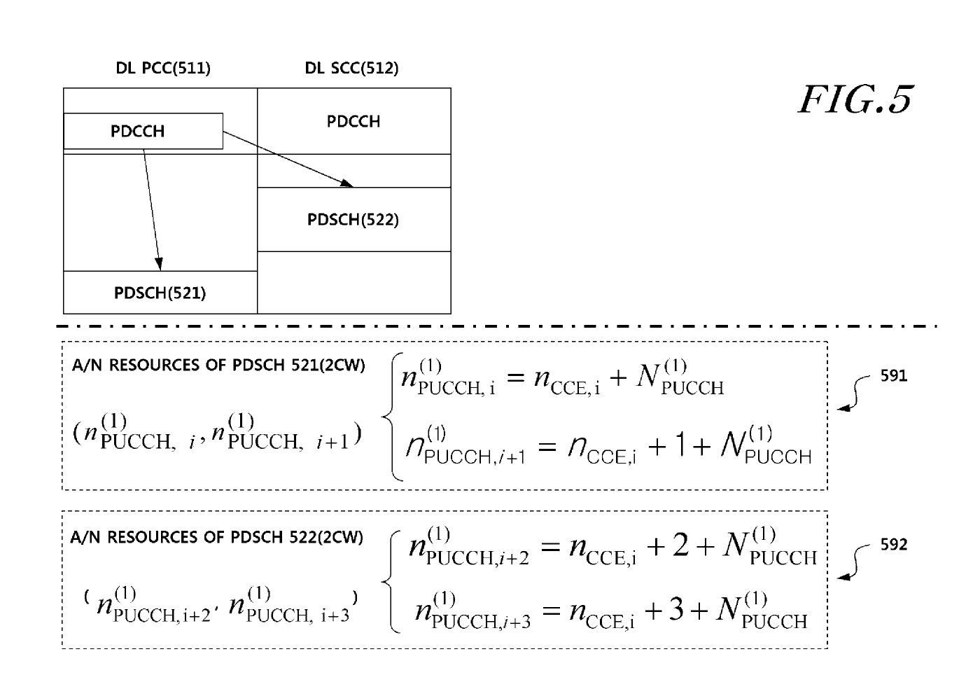

FIG. 5 is a diagram illustrating an example of allocating all resources of response control information using a CCE of a single PDCCH according to an embodiment of the present invention. In FIG. 5, n_{CCE,i} and N_{PUCCH}⁽¹⁾ calculated from a PDCCH are used.

With regard to a resource with respect to A/N of a PDSCH 521 transmitted on a PCC, in a case of 2 CW transmission, A/N resources with respect to 2 CWs are calculated by adding n_{CCE,i} and N_{PUCCH}⁽¹⁾ adding 1 to the sum, as shown in the diagram 591.

Also, with regard to a resource with respect to A/N of a PDSCH 522 transmitted on an SCC, in a case of 2 CW transmission, A/N resources with respect to 2 CWs are calculated by respectively adding 2 and 3 to the sum of n_{CCE,i} and N_{PUCCH}⁽¹⁾, as shown in the diagram 592 and Equation 2.

n_{PUCCH,i+2}⁽¹⁾=n_{CCE,i}+2+N_{PUCCH}⁽¹⁾,

n_{PUCCH,i+3}⁽¹⁾=n_{CCE,i}+3+N_{PUCCH}⁽¹⁾ [Equation 2]

In this case, 4 response control information resources are calculated through a single PDCCH. The resources are calculated by respectively adding 0, 1, 2, and 3 to information calculated from a single PDCCH and thus, 4 resources may be calculated. In this case, an eNB generates a PDCCH by providing 4 intervals so as not to overlap A/N resources to be transmitted by terminals.

SPS transmission uses Table 2 so as to derive a resource (n_{PUCCH, i}⁽¹⁾). In a case of a TM mode that supports 2 CWs, two response control information resources are calculated by adding 1 to a first resource, as shown in n_{PUCCH, i+1}⁽¹⁾=n_{PUCCH, i}⁽¹⁾+1.

A TPC value associated with downlink SPS scheduling is used as index information (resource index and indication information) that indicates PUCCH resource information, as shown in Table 2.

That is, in a case in which SPS scheduling is instructed, when a codeword is transmitted in a downlink, a TPC value indicates a resource of a PUCCH, for example, a resource to which response control information is to be included. Table 2 shows four cases that indicate a single resource. Each resource index is set in a higher layer, and is shared between a UE and an eNB.

When the scheme of FIG. 5 is applied, the scheme derives all PUCCH resources from a single PDCCH through PDCCH scheduling restriction without serious effect on the existing standard

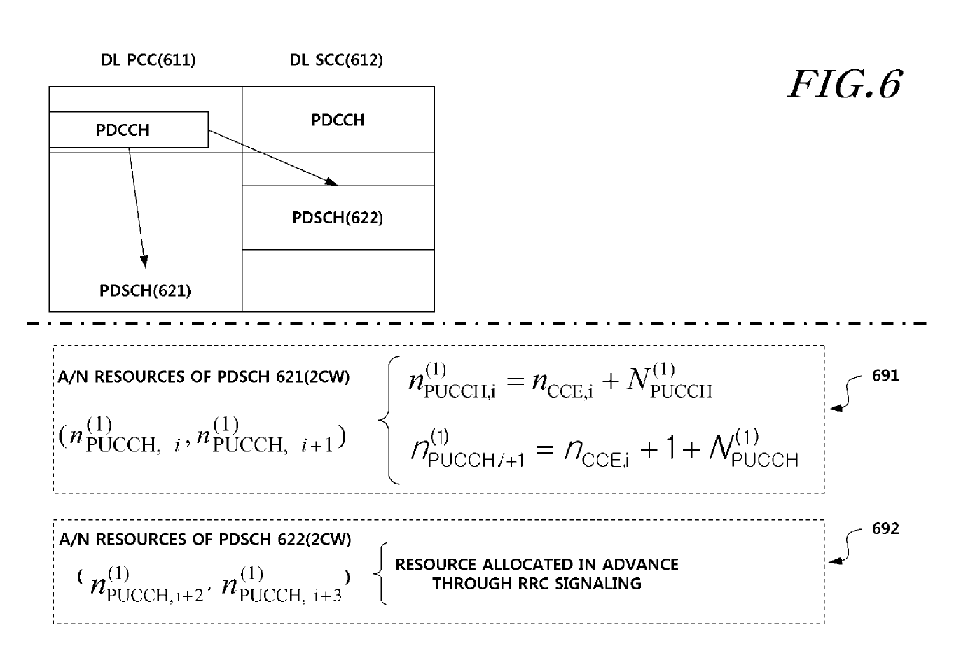

FIGS. 4 and 5 show a scheme that derives information of all resources using a single PDCCH, or a scheme that derives information of a resource transmitted on an SCC using a separate field. However, FIG. 6 illustrates an example in which A/N information of a PDSCH transmitted on an SCC allocates a resource in a semi-static manner through RRC signaling and the like.

As shown in FIG. 6, for a resource that carries A/N information with respect to a PDSCH 621 in a PCC, an existing method 691 is used. Information associated with resources (n_{PUCCH,i+2}⁽¹⁾, n_{PUCCH,i+3}⁽¹⁾) that carry A/N information with respect to a PDSCH 622 on an SCC is recognized by a UE through RRC and thus, A/N resources are allocated to the UE as shown in the diagram 692.

In this case, a resource of a PUCCH which is response control information with respect to a PDSCH of an SCC is allocated in advance through RRC and thus, the response control information of the PDSCH is effectively determined. RRC signaling has a greater time interval than resource allocation through a PDCCH and thus, overhead of a resource may occur.

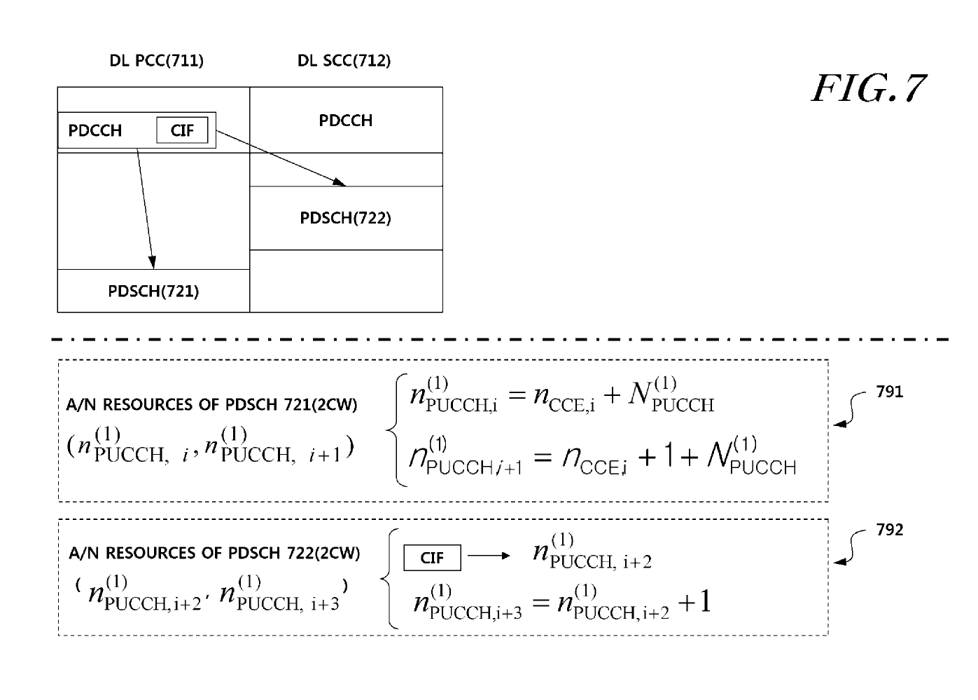

FIG. 7 is a diagram illustrating allocation of a resource using a CIF (Carrier Indicator Field) field according to an embodiment of the present invention.

A feature in which a single PDCCH indicates multiple PDSCHs may be used. As an example, information of a CIF field may be used. A single PDCCH indicates two or more PUSCHs and thus, the CIF field may not be used. Therefore, the CIF field may be used as an ARI field.

That is, when an existing CIF field is activated in a mode in which multiple PDSCH/PUSCH transmission is set to be scheduled by a single PDCCH (PDSCH/PUSCH scheduling on multiple cells by one PDCCH), the CIF field may be used to derive an A/N resource. With regard to a resource associated with A/N of a PDSCH 721 transmitted on a PCC, in a case of 2 CW transmission, information derived from a PDCCH is used in the same manner as described above, as shown in the diagram 791.

With respect to resources (n_{PUCCH,i+2}⁽¹⁾, n_{PUCCH,i+3}⁽¹⁾) associated with A/N of the PDSCH 721 transmitted on an SCC, information of a resource signaled in a higher layer is calculated using a value of a CIF field as shown in Table 3 or 4. Also, when the PDSCH 721 is 2 CWs, information of resources may be calculated by applying Table 4 or 5. As described above, to map Table 4 to resources of response control information with respect to 2 CWs, resources may be derived based on a scheme of adding 1 to a resource (n_{PUCCH,i+2}⁽¹⁾) with respect to a first CW, as shown in n_{PUCCH,i+3}⁽¹⁾=n_{PUCCH,i+2}⁽¹⁾+1.

In association with PUCCH format 1b with channel selection transmission of FIGS. 3, 4, 5, 6, and 7, a case in which a single PDCCH indicates two PDSCHs has been described. Hereinafter, transmission of PUCCH format 3 will be described.

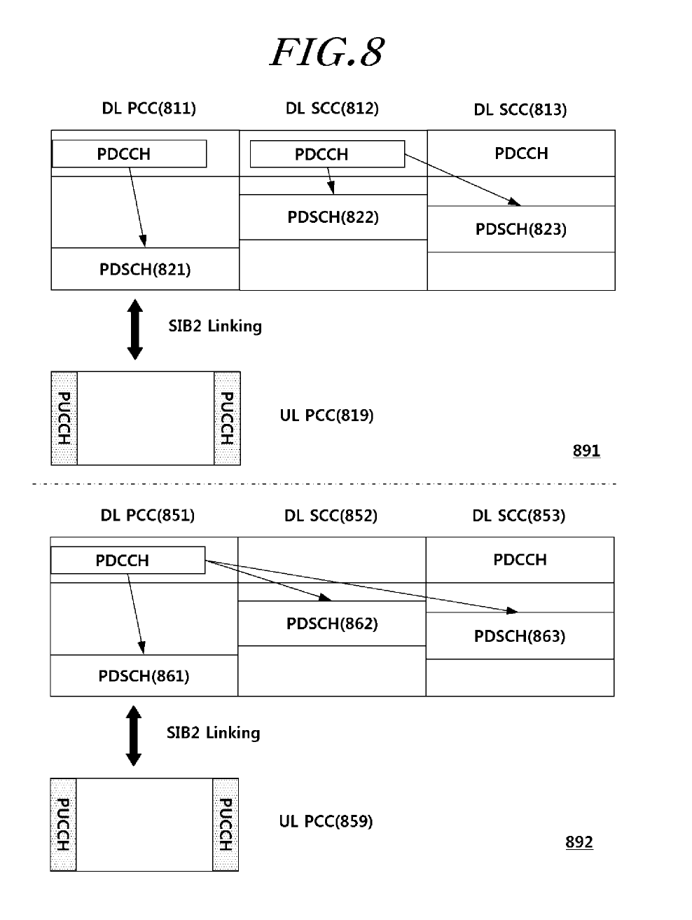

FIG. 8 is a diagram illustrating a case of allocating a resource for transmission of PUCCH format 3 using a single PDCCH.

In the diagram 891 of FIG. 8, a PDCCH of a DL PCC 811 indicates a single PDSCH 821, and a PDCCH of a DL SCC 812 indicates two PDSCHs 822 and 823. In the diagram 892 of FIG. 8, a PDCCH of a DL PCC 851 indicates three PDSCHs 861, 862, and 863.

FIG. 8 may also embody an allocation of a resource by adding a separate ARI field as described in FIG. 4. That is, even in a case of the PUCCH Format 3, a separate ARI field may be added to a DCI format in the same manner as the channel selection and thus, a TPC field is not reused and an A/N resource of the PUCCH format 3 may be derived in the case of the diagram 892.

A resource selected through the separate ARI field is used for PUCCH format 3 transmission. That is, unlike the PUCCH format 1b with channel selection, in the PUCCH format 3, a UE may transmit A/N with respect to all PDSCHs (both 1 CW and 2 CWs) transmitted on multiple CCs using only a single resource. Therefore, although only a resource is indicated through an ARI field, A/N may be transmitted with respect to all PDSCHs transmitted on multiple CCs.

When an SORTD (Spatial Orthogonal-Resource Transmit Diversity) (TxD for PUCCH format 3) scheme is applied, it is embodied that a selected single value (state) as shown in Table 6 indicates two resources of the PUCCH format 3. In a case in which a diversity scheme that transmits identical A/N information using two resources through two or more antennas is applied, although a single piece of information is selected in Table 6, it is embodied that two resources are allocated through the selected information.

TABLE 6
PUCCH resource information associated with HARQ-ACK
resource that is associated with a PUCCH in PUCCH format 3

| Value of | |
|---|---|
| ‘HARQ-ACK | |
| Resource for | |
| PUCCH’ | n_{PUCCH,i}⁽³⁾ |
| ‘00’ | The 1st PUCCH resource value configured by the higher |
| | layers |
| ‘01’ | The 2^{nd} PUCCH resource value configured by the higher |
| | layers |
| ‘10’ | The 3^{rd} PUCCH resource value configured by the higher |
| | layers |
| ‘11’ | The 4^{th} PUCCH resource value configured by the higher |
| | layers |

Even in the case of the diagram 891, a separate ARI field may be used. Also, a TPC of an SCell (SCC) is reused as an ARI, which is an existing method. That is, a TPC of a PDCCH of the diagram 812 is reused as an ARI.

A value of a CIF field may be used for resource allocation for PUCCH transmission resource of FIG. 8, as described in FIG. 7. When an existing CIF field is activated in a mode in which multiple PDSCH/PUCCH transmission is set to be scheduled by a single PDCCH, the CIF field is used for deriving an A/N resource.

In the case of the PUCCH format 3 associated with FIG. 8, a single resource is required and thus, it is embodied that information that indicates a single resource is separately included in an ARI field, or a CIF field is reused.

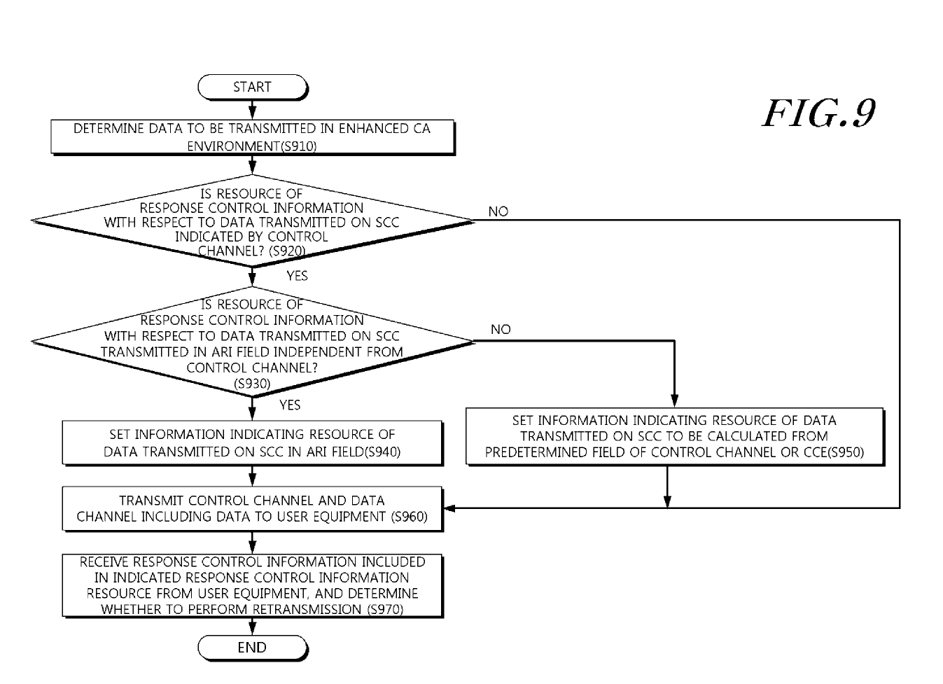

FIG. 9 is a diagram illustrating a process in which a base station transmits a PDCCH so as to enable allocation of a resource of a PUCCH according to an embodiment of the present invention.

A base station determines data to be transmitted in an enhanced CA environment in step S910. Here, the data is carried by a PDSCH, and is considered as a PDSCH for ease of description. Response control information with respect to the data to be transmitted may be the PUCCH format 1b with channel selection or the PUCCH format 3. As described in FIGS. 3 and 8, a case in which a single PDCCH indicates multiple PDSCHs is included. The base station determines whether a resource of the response control information with respect to the data transmitted on an SCC is indicated by a control channel in step S920. When the control channel (PDCCH) does not indicate a resource of response control information of data to be transmitted on an SCC, a case in which the resource is previously known through RRC signaling is included. In this example, separate indication information does not need to be included in the control channel and thus, the process proceeds with step S960.

When the resource of the response control information of the data to be transmitted on the SCC is included in the control channel, whether the resource is transmitted again in an independent ARI field, is transmitted in another field, or is derived from a number of CCEs and the like is determined in step S930. When the independent ARI field exists, information indicating the resource of the data transmitted on the SCC is set in the corresponding ARI field as shown in FIG. 4 in step S940. When the independent ARI field does not exist, it is set that the resource is calculated through a predetermined field or a CCE as described in FIGS. 5 and 7, in step S950.

Subsequently, a control channel and a data channel including the data are transmitted to the user equipment in step S960, and whether to perform retransmission is determined by receiving, from the user equipment, the response control information included in the indicated resource of the response control information.

Here, the data transmitted on the SCC may be 1 CW (codeword) or 2 CWs.

Also, when the data is transmitted in a state in which SPS transmission is activated, indication information associated with the resource of the response control information is included in a TPC which is a field for controlling power.

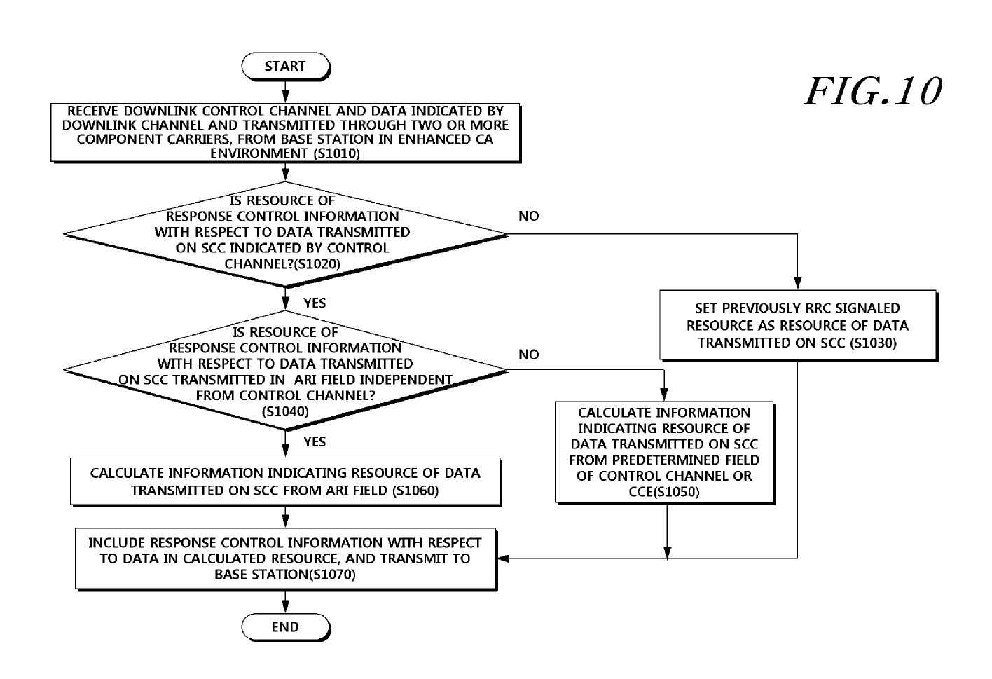

FIG. 10 is a diagram illustrating a process in which a user equipment derives a resource of response control information using a PDCCH transmitted to enable allocation of a resource of a PUCCH, and transmits the response control information according to an embodiment of the present invention.

The user equipment receives a downlink control channel and data that is indicated by the downlink channel and transmitted through two or more component carriers, from a base station in an enhanced CA environment in step S1010. Here, the data is a PDSCH, and response control information with respect to the data is the PUCCH format 1b with channel selection or the PUCCH format 3. As described in FIGS. 3 and 8, a case in which a single PDCCH indicates multiple PDSCHs is included. The user equipment extracts a resource of response control information with respect to data transmitted on an SCC based on a scheme that is previously agreed upon between the user equipment and the base station. When the desired resource is not indicated by the control channel, a case in which the resource is previously known by RRC signaling is included, as described in FIG. 6. In this case, the resource of the data transmitted on the SCC is set using information indicated by previously received RRC signaling in step S1030.

When the resource of the response control information of the data to be transmitted on the SCC is included in the control channel, a resource may be differently set based on whether the resource is transmitted again in an ARI field as illustrated in step S1040, is transmitted in another field, or is derived from a number of CCEs and the like. When the independent ARI field exists, information indicating the resource of the data transmitted on the SCC is calculated from the corresponding ARI field as described in FIG. 4, in step S1050. When the independent ARI field does not exist, it is set that the resource is calculated through a predetermined field of the control channel or a CCE as described in FIGS. 5 and 7, in step S1060.

Subsequently, the response control information with respect to the data is included in the calculated resource and is transmitted to the base station in step S1070.

Here, data transmitted on the SCC(Secondary Component Carrier) may be 1 CW (codeword) or 2 CWs.

Also, in the process of FIG. 9, when the data is transmitted in a state in which the SPS transmission is activated, indication information associated with the resource of the response control information may be included in a TPC which is a field for controlling power.

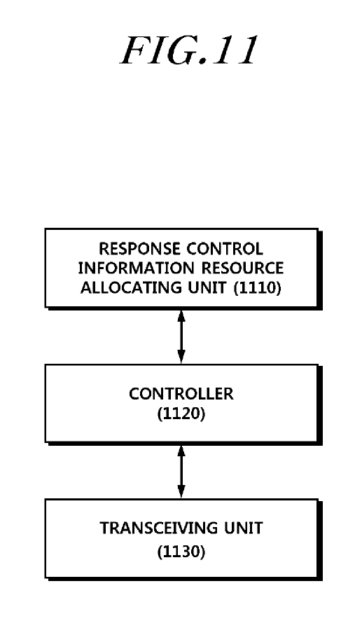

FIG. 11 is a diagram illustrating a configuration of an apparatus that transmits a PDCCH so as to enable allocation of a resource of a PUCCH according to an embodiment of the present invention. FIG. 11 is an embodiment of a base station, and the base station may include various component elements for providing a function of the base station in addition to the configuration of FIG. 11.

The overall configuration includes a response control information resource allocating unit 1110, a controller 1120, and a transceiving unit 1130. The response control information resource allocating unit 1110 calculates information indicating a resource of response control information with respect to data transmitted on two or more component carriers, and the controller 1120 includes the information in a downlink control channel. Here, the data is a PDSCH, and the response control information with respect to the data is the PUCCH format 1b with channel selection or the PUCCH format 3. As described in FIGS. 3 and 8, a case in which a single PDCCH indicates multiple PDSCHs is included. The transceiving unit 1130 transmits, to a user equipment, the control channel and a data channel including the data, and receives response control information included in the indicated response control information resource from the user equipment. Also, the controller 1120 determines whether to perform retransmission using the received response control information. As described above, information indicating a resource of response control information with respect to data transmitted on an SCC (Secondary Component Carrier) among the data may be included in the control channel or may be indicated by signaling in a higher layer.

That is, as illustrated in FIG. 6, when the resource of the response control information of the data transmitted on the SCC is previously indicated by RRC signaling, the controller 1120 does not need to include separate indication information in the control channel.

When a resource of response control information of data to be transmitted on an SCC is included in the control channel, whether the resource is transmitted again in an independent ARI field, is transmitted in another field, or is derived from a number of CCEs may be determined. Based on the determination, the controller 1120 includes the resource of the response control information in the independent ARI field as described in FIG. 4, or set that the resource is calculated through a predetermined field of the control channel or a CCE as described in FIGS. 5 and 7. The data transmitted on the SCC (Secondary Component Carrier) may be 1 CW (codeword) or 2 CWs. When the data is transmitted in a state in which SPS transmission is activated, the controller 1120 includes indication information associated with the resource of the response control information in a TPC field which is a field for controlling power.

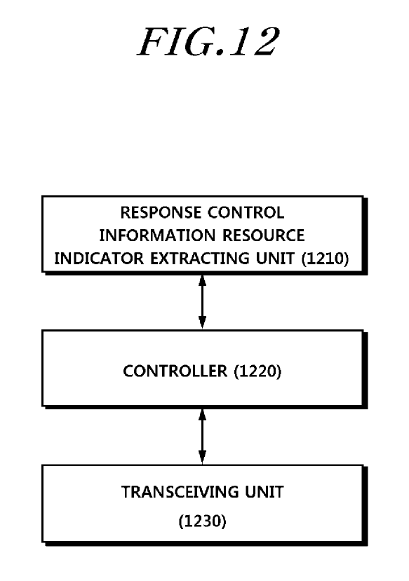

FIG. 12 is a diagram illustrating a configuration of an apparatus that is assigned with a resource of a PUCCH and transmits response control information according to an embodiment of the present invention. FIG. 12 is an embodiment of a user equipment, and the user equipment may include various component elements for providing a function of the user equipment in addition to the configuration of FIG. 12.

The overall configuration includes a response control information resource indicator extracting unit 1210, a controller 1220, and a transceiving unit 1230.

The transceiving unit 1230 receives, from a base station, a downlink control channel and data that is indicated by the downlink channel and is transmitted through two or more component carriers. Here, the data is a PDSCH, and response control information with respect to the data is the PUCCH format 1b with channel selection or the PUCCH format 3. As described in FIGS. 3 and 8, a case in which a single PDCCH indicates multiple PDSCHs is included. The response control information resource indicator extractor 1210 calculates, from the received control channel, information indicating a resource to which the response control information with respect to the data is to be included. Here, the response control information resource indicator extracting unit 1210 extracts a resource of the response control information with respect to the data transmitted on an SCC based on a scheme that is previously agreed upon between the user equipment and the base station. When the desired resource is not indicated by the control channel, a case in which the resource is previously known by RRC signaling is included as described in FIG. 6. In this case, the resource of the data transmitted on the SCC is determined using information indicated by previously received RRC signaling. When the resource of the response control information of the data transmitted on the SCC is included in the control channel, the resource may be differently set based on whether the resource is transmitted again in an independent ARI field, is transmitted in another field, or is derived from a number of CCEs. When the independent ARI field exists, the response control information resource indicator extracting unit 1210 calculates information that indicates the resource of the data transmitted on the SCC from the corresponding ARI field as described in FIG. 4. When the independent ARI field does not exist, the response control information resource indicator extracting unit 1210 performs setting so that the resource is calculated from a predetermined field of the control channel or a CCE as described in FIGS. 5 and 7. The controller 1220 includes the response control information with respect to the data in the resource. The transceiving unit 1230 transmits the resource including the response control information to the base station as a wireless signal. Here, information indicating a resource of response control information with respect to data transmitted on an SCC(Secondary Component Carrier) from among the data may be included in the control channel or may be indicated by signaling of a higher layer.

When the data that the apparatus of FIG. 12 receives is received in a process in which SPS transmission is activated, indication information associated with the resource of the response control information may be included in a TPC which is a field for controlling power. Therefore, the response control information resource indicator extracting unit 1210 determines the resource of the response control information using information of the TPC field.

The present specifications proposes a method of deriving a resource for PUCCH A/N transmission when an enhanced PDCCH scheduling method is activated, and an apparatus for allocating a resource and including response control information in the allocated resource for transmission, using the method. An existing PUCCH resource allocating method may not be used in the enhanced PDCCH scheduling and thus, the present specification provides a new PUCCH resource allocating method. Through this method, transmission efficiency of A/N information is improved and the overall system performance is dramatically enhanced.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of allocating a resource of response control information, the method comprising the steps of:
including, in a single downlink control channel, information indicating a resource of response control information with respect to data transmitted through two or more component carriers;
transmitting, to a user equipment, the control channel and two or more data channels including the data; and
receiving, from the user equipment, the response control information included in the indicated resource of response control information, and determines whether to perform retransmission,
wherein information that indicates a resource of response control information with respect to data transmitted on an Secondary Component Carrier (SCC) from among the data is included in the control channel, or is indicated by signaling of a higher layer.

2. The method of claim 1, wherein the data transmitted on the SCC corresponds to 1 codeword (CW) or 2 CWs; and
when the information indicating the resource of the response control information is included in the control channel, the resource of the response control information with respect to the 1 CW or 2 CWs is indicated by an ACK/NACK Resource Indicator (ARI) field that is independent from the control channel, is indicated by a Carrier Indicator Field (CIF) of the control channel, or is derived from a number of Control Channel Elements (CCEs) of the control channel.

3. The method of claim 1, wherein, when the data is transmitted in a state in which Semi-Persistent Scheduling (SPS) transmission is activated, the information indicating the resource of the response control information is included in a Transmit Power Control (TPC) field, which is a field for controlling power.

4. A method of allocating a resource of response control information, the method comprising the steps of:
receiving, from a base station, a single downlink control channel and a data channel that is indicated by the downlink control channel and is transmitted through two or more component carriers; and
calculating, from the received control channel, information indicating a resource to which response control information with respect to data included in the data channel is to be included, and including the response control information with respect to the data in the resource for transmission to the base station,
wherein information indicating a resource of response control information with respect to data transmitted on a Secondary Component Carrier (SCC) from among the data is included in the single control channel, or is indicated by signaling of a higher layer.

5. The method of claim 4, wherein the data transmitted on the SCC corresponds to 1 codeword (CW) or 2 CWs; and
when the resource of the response control information is included in the control channel, the resource of the response control information with respect to 1 CW or 2 CWs is indicated by an ACK/NACK Resource Indicator (ARI) field that is independent from the control channel, is indicated by a Carrier Indicator Field (CIF) of the control channel, or is derived from a number of Control Channel Elements (CCEs) of the control channel.

6. The method of claim 4, wherein, when the data is transmitted in a state in which Semi-Persistent Scheduling (SPS) transmission is activated, indication information associated with the resource of the response control information is included in a Transmit Power Control (TPC) field that is a field for controlling power.

7. A method of allocating a resource of response control information, the method comprising the steps of:
including information indicating a resource of response control information with respect to one or more pieces of data transmitted on a Primary Component Carrier (PCC) and information indicating a resource of response control information with respect to two or more pieces of data transmitted on a Secondary Component Carrier (SCC) in a downlink control channel of the PCC or in downlink control channels of the PCC and an SCC;
transmitting, to a user equipment, a control channel and three or more data channels including the data; and
receiving, from the user equipment, response control information included in the indicated response control information resource, and determining whether to perform retransmission,
wherein the information indicating the resource of the response control information with respect to the data transmitted on the SCC is included in the control channel or is indicated by signaling of a higher layer.

8. The method of claim 7, wherein, in a case in which the data transmitted on the SCC corresponds to 1 codeword (CW) or 2 CWs, when information indicating the resource of the response control information is included in the control channel, the resource of the response control information with respect to the 1 CW or 2 CWs is indicated by an ACK/NACK Resource Indicator (ARI) field that is independent from the control channel, is indicated by a Carrier Indicator Field (CIF) of the control channel, or is derived from a number of Control Channel Elements (CCEs) of the control channel; and
in a case in which the data is transmitted in a state in which Semi-Persistent Scheduling (SPS) transmission is activated, the information indicating the resource of the response control information is included in a Transmit Power Control (TPC) field that is a field for controlling power.

9. A method of allocating a resource of response control information, the method comprising the steps of:
receiving, from a base station, a control channel and three or more data channels including data, wherein information indicating a resource of response control information with respect to one or more pieces of data transmitted on a Primary Component Carrier (PCC) and information indicating a resource of response control information with respect to two or more pieces of data transmitted on a Secondary Component Carrier (SCC) are included in a downlink control channel of the PCC or in downlink control channels of the PCC and an SCC; and
calculating, from the received control channel, information that indicates a resource to which response control information with respect to the data included in the data channel is to be included, and including the response control information with respect to the data in the resource for transmission to the base station,
wherein the information indicating the resource of the response control information with respect to the data transmitted on the SCC is included in the control channel or is indicated by signaling of a higher layer.

10. The method of claim 9, wherein, in a case in which the data transmitted on the SCC corresponds to 1 codeword (CW) or 2 CWs, when information indicating the resource of the response control information is included in the control channel, the resource of the response control information with respect to 1 CW or 2 CWs is indicated by an ACK/NACK Resource Indicator (ARI) field that is independent from the control channel, is indicated by a Carrier Indicator Field (CIF) of the control channel, or is derived from a number of Control Channel Elements (CCEs) of the control channel; and
in a case in which the data is transmitted in a state in which Semi-Persistent Scheduling (SPS) transmission is activated, information indicating the resource of the response control information is included in a Transmit Power Control (TPC) field that is a field for controlling power.

11. A base station in a wireless system that uses one or more component carriers, the base station comprising:
a response control information resource allocating unit to calculate information indicating a resource of response control information with respect to data transmitted through two or more component carriers;
a controller to include the information in a single downlink control channel; and
a transceiving unit to transmit the control channel and two or more data channels including the data to a user equipment, and to receive, from the user equipment, the response control information included in the indicated resource of response control information,
wherein the controller determines whether to perform retransmission using the received response control information; and
information indicating a resource of response control information with respect to data transmitted on a Secondary Component Carrier (SCC) from among the data is included in the control channel or is indicated by signaling of a higher layer.

12. The base station of claim 11, wherein, in a case in which the data transmitted on the SCC corresponds to 1 codeword (CW) or 2 CWs, when information indicating the resource of the response control information is included in the control channel, the resource of the response control information with respect to the 1 CW or 2 CWs is indicated by an ACK/NACK Resource Indicator (ARI) field that is independent from the control channel, is indicated by a Carrier Indicator Field (CIF) of the control channel, or is derived from a number of Control Channel Elements (CCEs) of the control channel; and
in a case in which the data is transmitted in a state in which Semi-Persistent Scheduling (SPS) transmission is activated, the controller includes information indicating the resource of the response control information in a Transmit Power Control (TPC) field that is a field for controlling power.

13. A user equipment, comprising:
a transceiving unit to receive, from a base station, a single downlink control channel and a data channel that is indicated by the downlink control channel and is transmitted through two or more component carriers;
a response control information resource indicator extracting unit to calculate, from the received control channel, information indicating a resource to which response control information with respect to data included in the data channel is to be included; and
a controller to include the response control information with respect to the data in the resource,
wherein the transceiving unit transmits, to the base station, the resource including the response control information as a wireless signal, and
information indicating a resource of response control information with respect to data transmitted on a Secondary component Carrier (SCC) from among the data is included in the control channel or is indicated by signaling of a higher layer.

14. The user equipment of claim 13, wherein, when the data transmitted on the SCC corresponds to 1 codeword (CW) or 2 CWs, the response control information resource indicator extracting unit calculates the information of the resource of the response control information with respect to the 1 CW or 2 CWs from an ACK/NACK Resource Indicator (ARI) field that is independent from the control channel, a Carrier Indicator Field (CIF) of the control channel, or a number of Control Channel Elements (CCEs) of the control channel; and
when the data is transmitted in a state in which Semi-Persistent Scheduling (SPS) transmission is activated, the response control information resource indicator extracting unit extracts indication information associated with the resource of the response control information from a Transmit Power Control (TPC) field that is a field for controlling power.
